(19) United States
(12) Patent Application Publication
(10) Pub. No.: US 2026/0314611 A1
(43) Pub. Date: Oct. 15, 2026

(54) MULTIFUNCTIONAL CHICKEN BONE SHEARS

(71) Applicant: Changzong XIAN, Yangjiang (CN)

(72) Inventor: Changzong XIAN, Yangjiang (CN)

(21) Appl. No.: 19/220,585

(22) Filed: May 28, 2025

(30) Foreign Application Priority Data
Apr. 15, 2025 (CN) 2025207158908

(51) Int. Cl. A22C 21/00; A22C 17/06; B26B 13/08; B26B 13/22; B26B 13/28

(52) U.S. Cl. CPC A22C 21/0023; A22C 17/06; B26B 13/08; B26B 13/22; B26B 13/28

(57) ABSTRACT

Disclosed are multifunctional chicken bone shears, including a first shearing unit and a second shearing unit, where each shearing unit includes a blade, the blade includes a cutting portion and a handle portion, and a hinge hole is formed between the cutting portion and the handle portion of the blade; a hinge shaft passes through the hinge holes of the two shearing units to realize a hinged connection between the two shearing units; shear edges are provided on opposing portions of the cutting portion on the blade of each shearing unit, the cutting portion on the blade of the first shearing unit is located below the cutting portion on the blade of the second shearing unit, and a cutting edge is arranged beneath the shear edge of the cutting portion on the blade of the first shearing unit.

### CROSS-REFERENCE TO RELATED APPLICATIONS

The application claims priority to Chinese patent application No. 2025207158908, filed on Apr. 15, 2025, the entire contents of which are incorporated herein by reference.

### TECHNICAL FIELD

The present disclosure relates to kitchen shears, and in particular to multifunctional chicken bone shears.

### BACKGROUND

Chicken bone shears are a kitchen tool specially designed for processing chicken bones, and are also usually referred to as kitchen shears. The shears feature a sturdy and durable design capable of cutting through chicken bones, separating chicken meat, and trimming excess fat or fascia. They are suitable for general use in kitchens.

The Chinese Patent (Application No.: CN202420636424.6) discloses chicken bone shears that include a right shear handle and a left shear handle, where a disassembly locking plate is secured in a slot on the right shear handle via a locking pin of the disassembly locking plate, a spring is connected between the disassembly locking plate and the slot. When the right shear handle and the left shear handle are used together as shears, the left shear handle is restricted by the locking plate to prevent it from detaching from the right shear handle. By pressing the disassembly locking plate, the restriction of the left shear handle is released, and the left shear handle can be detached from the right shear handle to be used a cutter. However, converting the shears into a cutter requires disassembling components, which makes the conversion cumbersome. Moreover, once disassembled, the shears must be reassembled before they can be used again. When the detached right shear handle or other parts are stored improperly or for a long period, they are easily lost. In addition, the blade of the left shear handle is a single-bevel blade, resulting in low cutting precision and greater difficulty in cutting operation.

### SUMMARY

The present disclosure aims to solve the technical problem of providing multifunctional chicken bone shears capable of being easily converted into a cutter.

In order to solve the above technical problem, the present disclosure adopts the following technical solution: multifunctional chicken bone shears, including a first shearing unit and a second shearing unit, where each shearing unit includes a blade, the blade includes a cutting portion and a handle portion, and a hinge hole is formed between the cutting portion and the handle portion of the blade; a hinge shaft passes through the hinge holes of the two shearing units to realize a hinged connection between the two shearing units; shear edges are provided on opposing portions of the cutting portion on the blade of each shearing unit, the cutting portion on the blade of the first shearing unit is located below the cutting portion on the blade of the second shearing unit, and a cutting edge is arranged beneath the shear edge of the cutting portion on the blade of the first shearing unit.

For the multifunctional chicken bone shears, the cutting edge is a double-sided edge, and the cutting portion on the blade of the first shearing unit includes a serrated edge located at a front portion of the shear edge and an arc-shaped concave edge located at a rear portion of the shear edge.

For the multifunctional chicken bone shears, a hinged portion of the two shearing units includes a shear elastic opening mechanism and a shear closing locking mechanism.

For the multifunctional chicken bone shears, the shear elastic opening mechanism includes a torsion spring, an annular mounting recess for accommodating the torsion spring is formed on an inner side of the blade of each shearing unit, the annular mounting recess is coaxial with the hinge hole, and an end-foot recess for accommodating a torsion arm of the torsion spring is formed on an outer edge of the annular mounting recess; and the annular mounting recess of each shearing unit is provided with one torsion spring, two torsion arms of the torsion spring are respectively arranged in the end-foot recesses of the two annular mounting recesses, and elastic force of the torsion spring causes the cutting portions of the two shearing units to open.

For the multifunctional chicken bone shears, each shearing unit includes a plastic handle, and the handle portion of the blade is embedded in the plastic handle.

For the multifunctional chicken bone shears, the handle portion of the blade is riveted to the plastic handle via a plurality of rivets, and a top of the plastic handle of the first shearing unit and a bottom of the plastic handle of the second shearing unit are coated with respective silicone layers.

For the multifunctional chicken bone shears, a rear end of the cutting portion of the blade each shearing unit is connected to a front end of the handle portion, a rear section of the handle portion of the blade of the second shearing unit is embedded in the plastic handle, and a latch slot that opens rearward for the shear closing locking mechanism is formed on an upper portion of a front section of the handle portion of the blade of the second shearing unit; a slot that opens downward is formed on a front end of the plastic handle of the first shearing unit; when the two shearing units are closed together, an upper portion of the front section of the handle portion of the blade of the second shearing unit is inserted into the slot; a transversely through oblong hole is formed on a front portion of the plastic handle of the first shearing unit, and the oblong hole passes through the slot transversely; and the shear closing locking mechanism includes a locking pin, the locking pin passes through the oblong hole, and a clearance hole for the locking pin is formed on the handle portion of the blade of the first shearing unit; when the two shearing units are closed together, the locking pin moves forward in a major axis direction of the oblong hole and is engaged in the latch slot on the upper portion of the front section of the handle portion of the blade of the second shearing unit; and when the two shearing units are open, the locking pin moves backward in the major axis direction of the oblong hole, and is disengaged from the latch slot on the upper portion of the front section of the handle portion of the blade of the second shearing unit.

For the multifunctional chicken bone shears, the locking pin includes a rivet, a damping spring, and a spring washer, each end of the oblong hole is provided with an elongated annular groove, the spring washer is located on a bottom of one elongated annular groove, the rivet passes through the damping spring, the spring washer, and the oblong hole, and each end of the rivet is provided with a rivet head; and one end of the damping spring abuts against the spring washer, and the other end abuts against a bottom surface of one rivet head.

For the multifunctional chicken bone shears, the shears further include a shear sheath, the shear sheath includes a plastic sheath and a metal clip, and the plastic sheath includes two side plates; at an opening portion of a rear portion of the plastic sheath, an arc-shaped groove is formed on a first side plate, and a central angle corresponding to the arc-shaped groove is greater than 180°; when the cutting portions of the two shearing units are inserted into the plastic sheath, a first rivet head at an end of the hinge shaft is engaged in the arc-shaped groove; a fixed end of the metal clip is secured to a rear end of a second side plate of the plastic sheath via screws, and an opening direction of the metal clip faces forward; and the second side plate is provided with an elongated hole with its major axis oriented in a front-to-rear direction, and a concave beam is disposed in the elongated hole in a major axis direction.

For the multifunctional chicken bone shears, the shear sheath includes a magnet, a magnet slot is formed on the second side plate, and the magnet is embedded in the magnet slot; and when the cutting portions of the two shearing units are inserted into the plastic sheath, the magnet is close to a second rivet head at the end of the pivot shaft.

The multifunctional chicken bone shears provided by the present disclosure can be directly used as a cutter when the two shearing units are closed together. When the two shearing units are opened, it can be used as shears. The conversion process does not require disassembly or assembly of any parts, making the conversion simple and convenient.

### BRIEF DESCRIPTION OF DRAWINGS

The present disclosure will be further illustrated below in conjunction with the accompanying drawings and specific embodiments.

FIG. 1 is a front view of multifunctional chicken bone shears according to an embodiment of the present disclosure.

FIG. 2 is a top view of multifunctional chicken bone shears according to an embodiment of the present disclosure.

FIG. 3 is a rear view of multifunctional chicken bone shears according to an embodiment of the present disclosure.

FIG. 4 is a perspective view of multifunctional chicken bone shears according to an embodiment of the present disclosure.

FIG. 5 is a front view of multifunctional chicken bone shears with a shear sheath removed according to an embodiment of the present disclosure.

FIG. 6 is a rear view of multifunctional chicken bone shears with a shear sheath removed according to an embodiment of the present disclosure.

FIG. 7 is one perspective view of multifunctional chicken bone shears with a shear sheath removed according to an embodiment of the present disclosure.

FIG. 8 is another perspective view of multifunctional chicken bone shears with a shear sheath removed according to an embodiment of the present disclosure.

FIG. 9 is a front view of multifunctional chicken bone shears in an open state according to an embodiment of the present disclosure.

FIG. 10 is a perspective view of a second shearing unit of multifunctional chicken bone shears according to an embodiment of the present disclosure.

FIG. 11 is one perspective view of a blade of a second shearing unit of multifunctional chicken bone shears according to an embodiment of the present disclosure.

FIG. 12 is another perspective view of a blade of a second shearing unit of multifunctional chicken bone shears according to an embodiment of the present disclosure.

FIG. 13 is a perspective view of a plastic handle of a second shearing unit of multifunctional chicken bone shears according to an embodiment of the present disclosure.

FIG. 14 is a perspective view of a first shearing unit of multifunctional chicken bone shears according to an embodiment of the present disclosure.

FIG. 15 is one perspective view of a blade of a first shearing unit of multifunctional chicken bone shears according to an embodiment of the present disclosure.

FIG. 16 is another perspective view of a blade of a first shearing unit of multifunctional chicken bone shears according to an embodiment of the present disclosure.

FIG. 17 is a perspective view of a plastic handle of a first shearing unit of multifunctional chicken bone shears according to an embodiment of the present disclosure.

FIG. 18 is a perspective view of a torsion spring of multifunctional chicken bone shears according to an embodiment of the present disclosure.

FIG. 19 is a front view of a locking pin of multifunctional chicken bone shears according to an embodiment of the present disclosure.

FIG. 20 is a rear view of multifunctional chicken bone shears in an open state according to an embodiment of the present disclosure.

FIG. 21 is a sectional view of A-A in FIG. 20.

FIG. 22 is a sectional view of B-B in FIG. 20.

FIG. 23 is a perspective view of a shear sheath of multifunctional chicken bone shears according to an embodiment of the present disclosure.

FIG. 24 is a front view of a shear sheath of multifunctional chicken bone shears according to an embodiment of the present disclosure.

FIG. 25 is a rear view of a shear sheath of multifunctional chicken bone shears according to an embodiment of the present disclosure.

FIG. 26 is a sectional view of C-C in FIG. 25.

FIG. 27 is a rear view of a plastic sheath of multifunctional chicken bone shears according to an embodiment of the present disclosure.

### DETAILED DESCRIPTION OF THE EMBODIMENTS

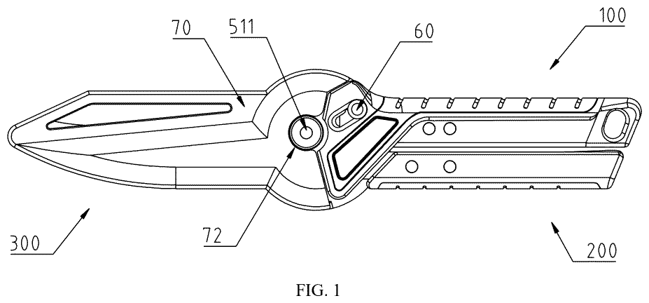

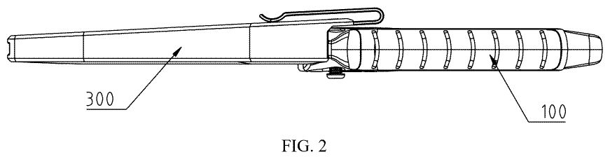

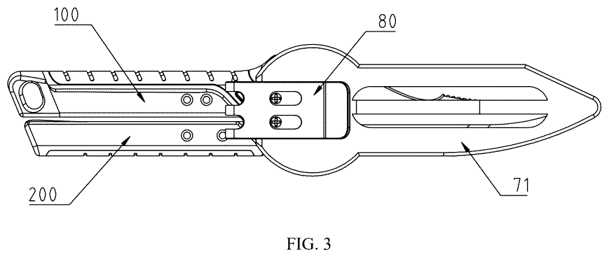

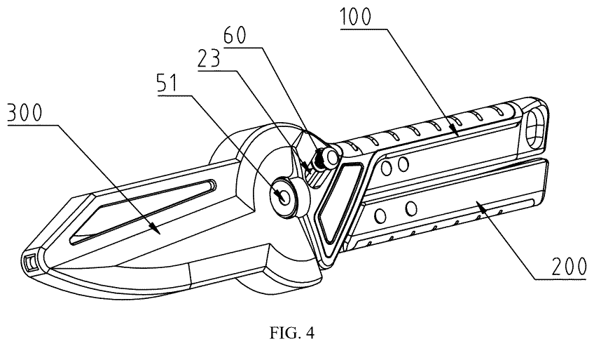

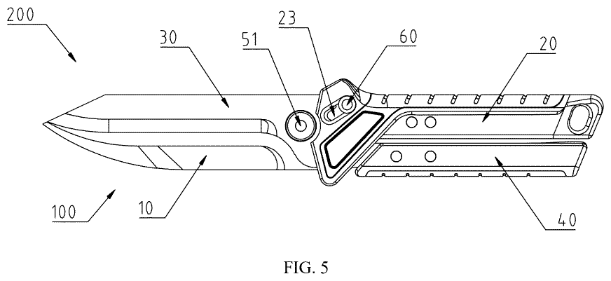

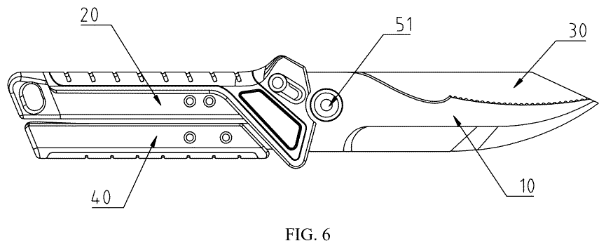

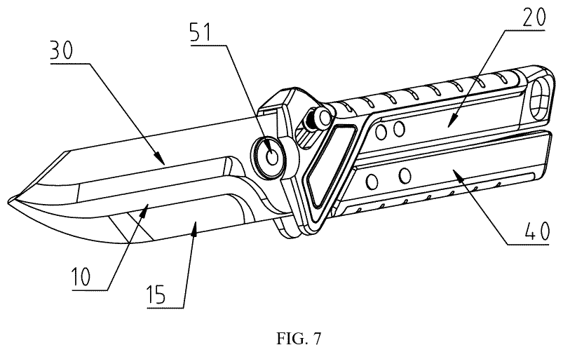

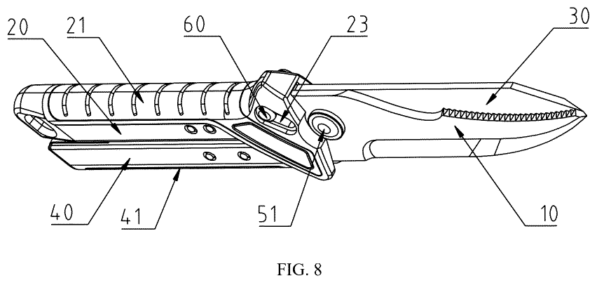

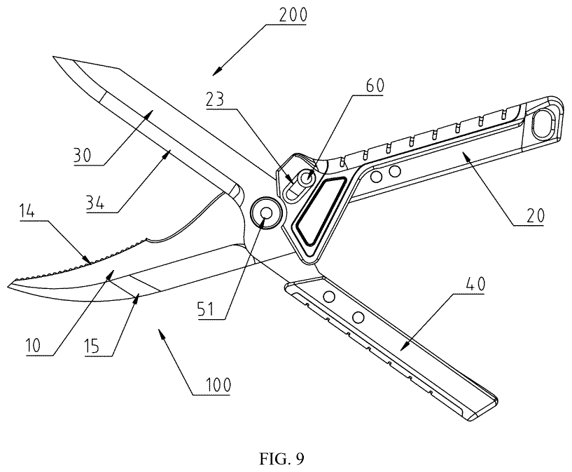

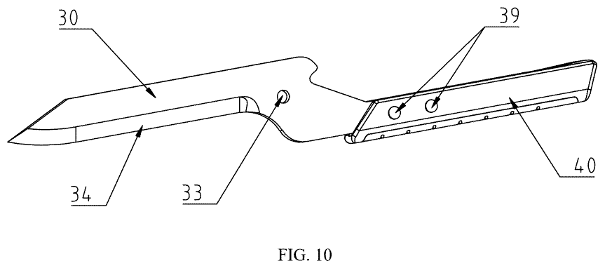

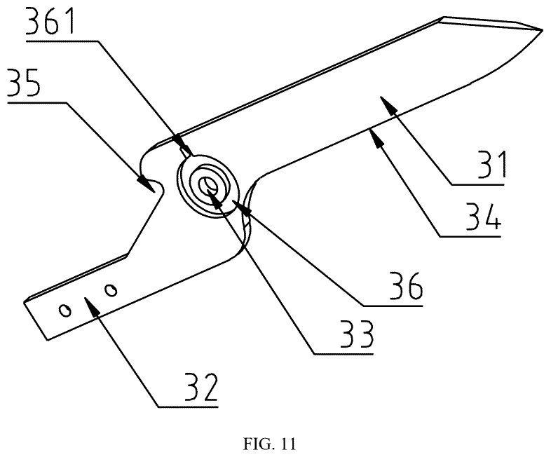

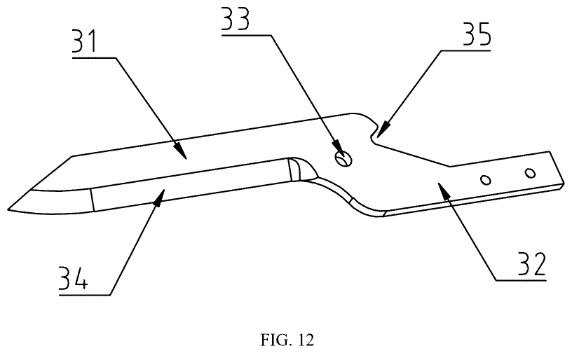

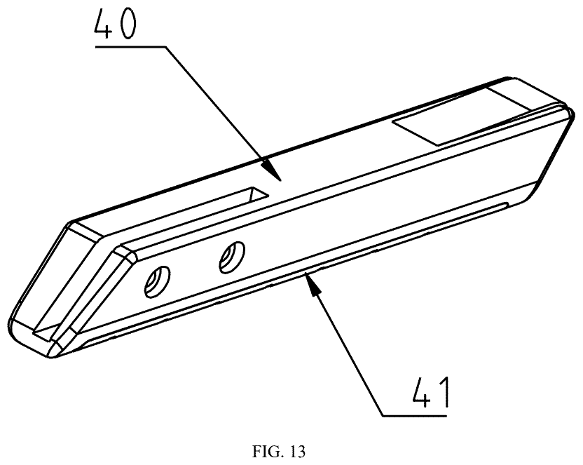

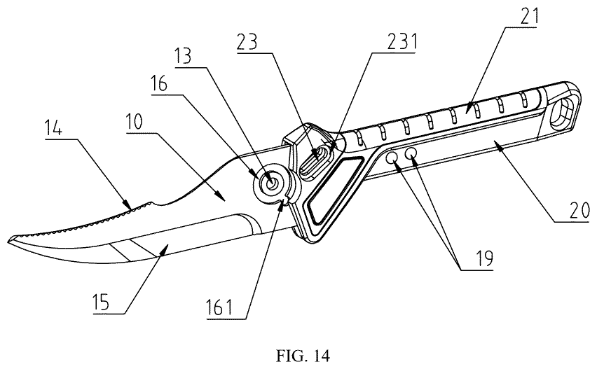

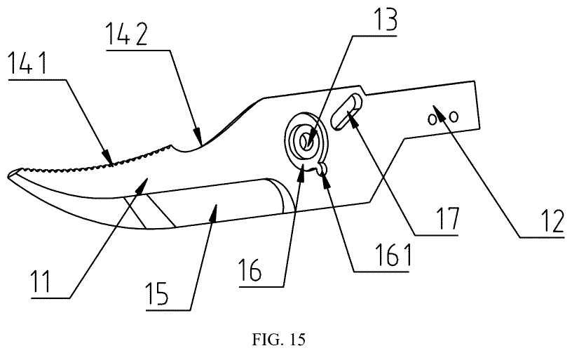

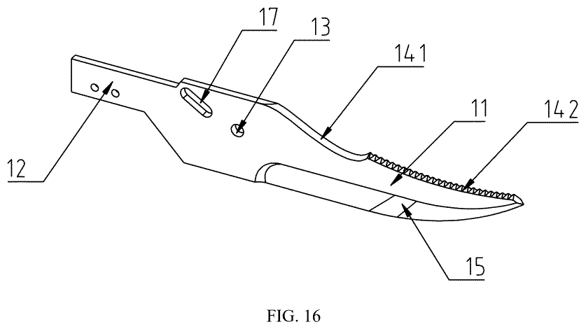

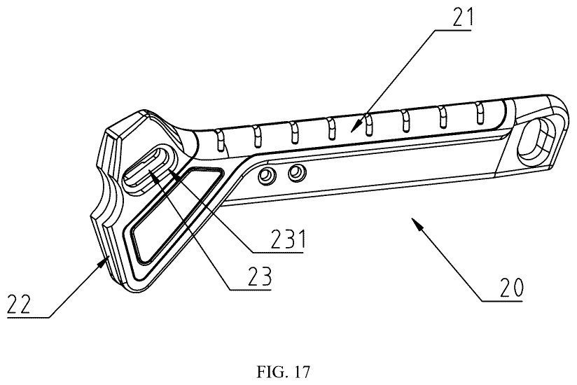

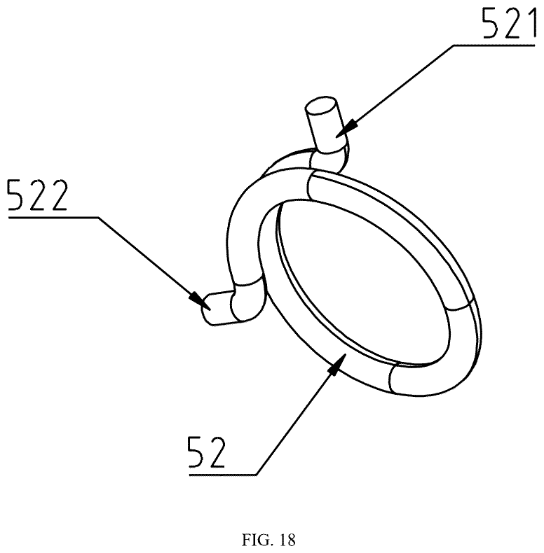

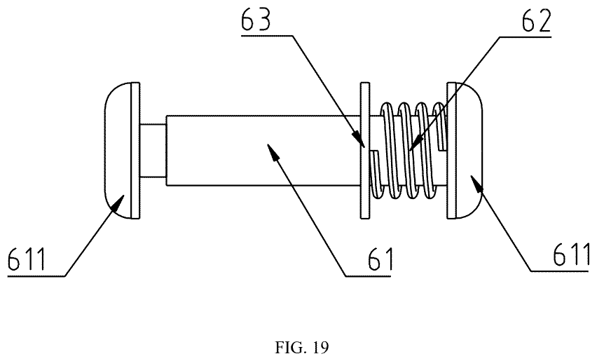

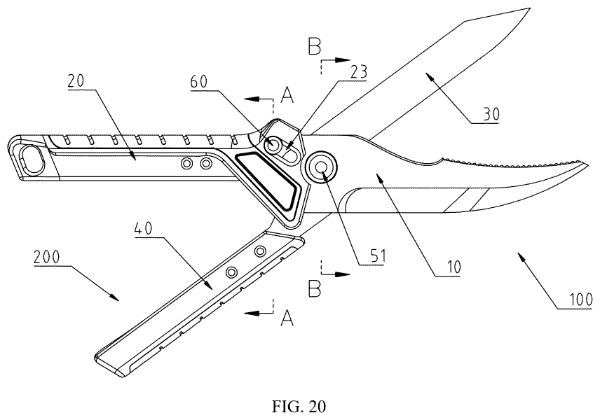

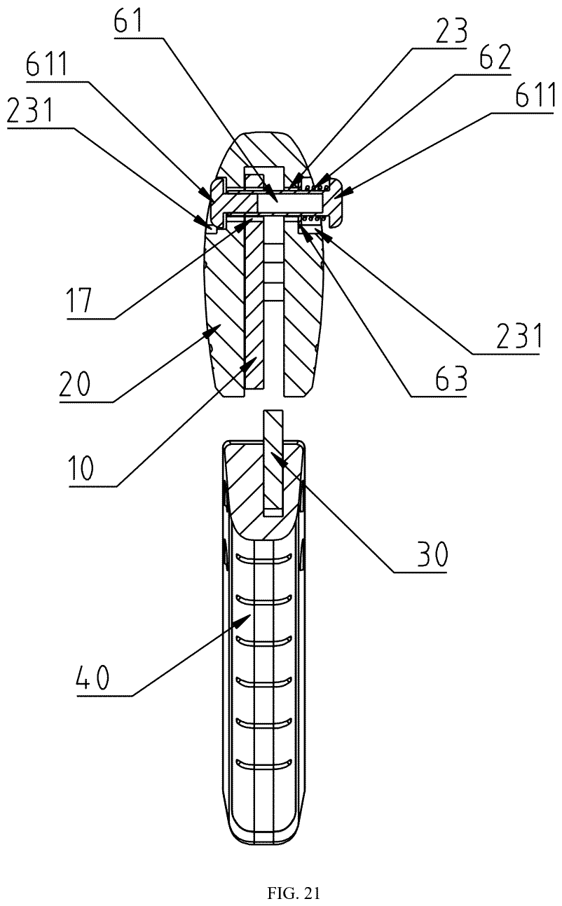

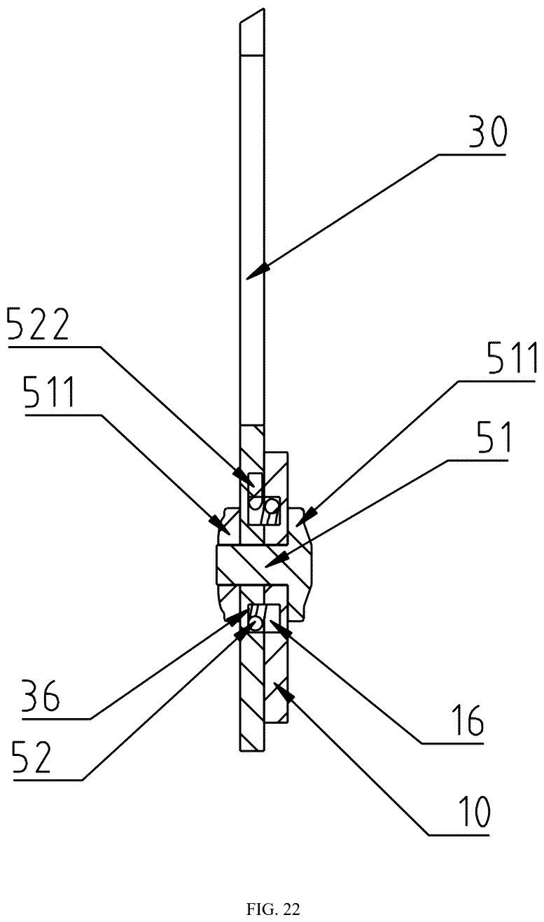

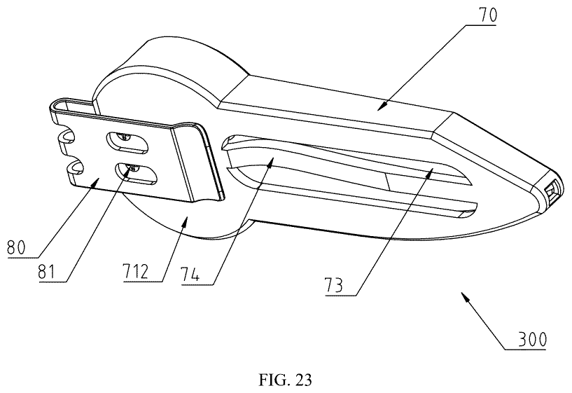

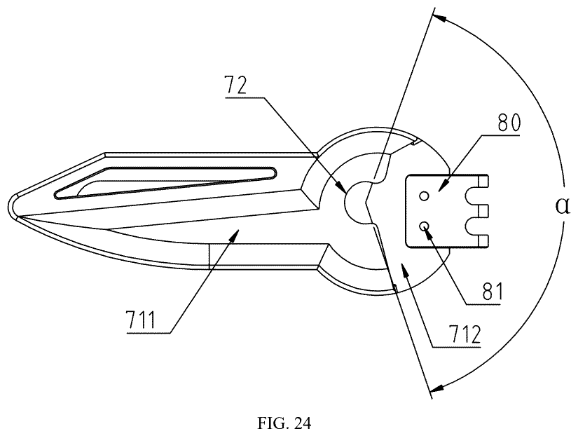

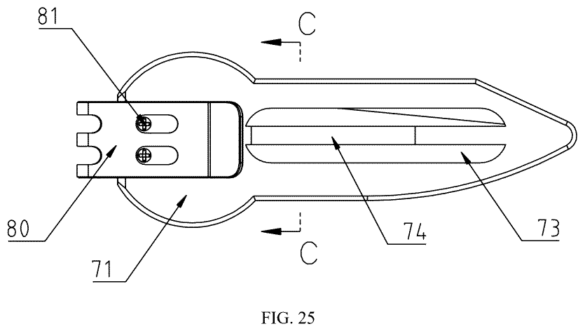

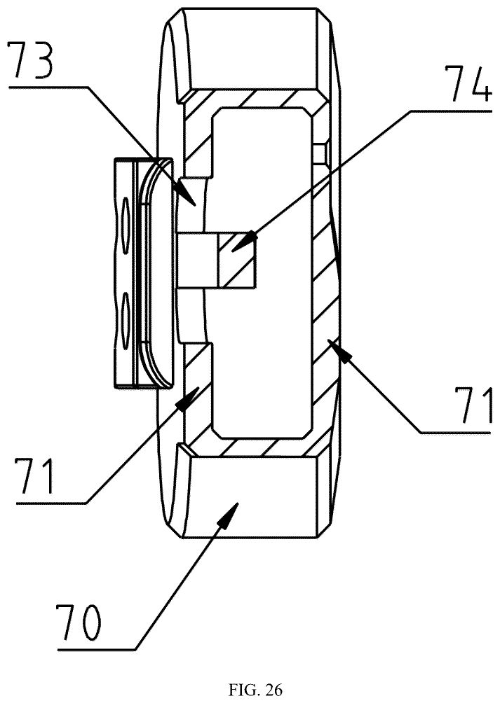

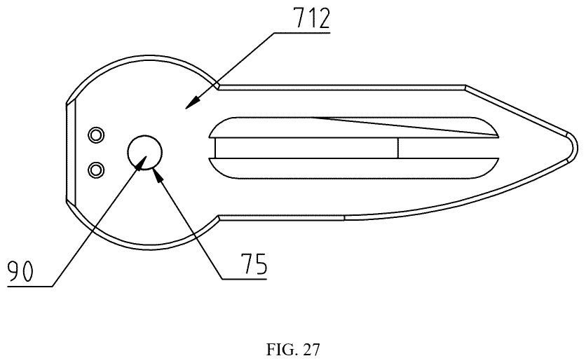

A structure of multifunctional chicken bone shears of the present disclosure is shown in FIGS. 1-27, the chicken bone shears include a first shearing unit 100 and a second shearing unit 200, where the first shearing unit 100 includes a blade 10 and a plastic handle 20, the blade 10 includes a cutting portion 11 and a handle portion 12, and the handle portion 12 of the blade 10 is embedded in the plastic handle 20. A hinge hole 13 is formed between the cutting portion 11 and the handle portion 12 of the blade 10. The second shearing unit 200 includes a blade 30 and a plastic handle 40, the blade 30 includes a cutting portion 31 and a handle portion 32, and the handle portion 32 of the blade 30 is embedded in the plastic handle 40. A hinge hole 33 is formed between the cutting portion 31 and the handle portion 32 of blade 30.

The handle portion 12 of the blade 10 of the first shearing unit 100 is riveted to the plastic handle 20 via two rivets 19, and the handle portion 32 of the blade 30 of the second shearing unit 200 is riveted to the plastic handle 40 via two rivets 39. A top of the plastic handle 20 of the first shearing unit 100 is coated with a silicone layer 21, and a bottom of the plastic handle 40 of the second shearing unit 200 is coated with a silicone layer 41.

A hinge shaft 51 passes through the hinge hole 13 of the first shearing unit 100 and the second hinge hole 33 of the second shearing unit 200 to realize a hinged connection between the two shearing units. A circular rivet head 511 is formed at each end of the hinge shaft 51.

A shear edge 14 is disposed on an upper edge of the cutting portion 11 on the blade 10 of the first shearing unit 100, and a shear edge 34 is disposed on a lower edge of the cutting portion 31 of the blade 30 of the second shearing unit 200. When the multifunctional chicken bone shears are open, the cutting portion 11 on the blade 10 of the first shearing unit 100 is located below the cutting portion 31 on the blade 30 of the second shearing unit 200, a cutting edge 15 is arranged on a lower edge of the cutting portion 11 (beneath the shear edge 14) on the blade 10 of the first shearing unit 100, and the cutting edge 15 is a symmetrical double-sided edge.

The upper edge of the cutting portion 11 on the blade 10 of the first shearing unit 100 includes a serrated edge 141 located at a front portion of the shear edge 14 and an arc-shaped concave edge 142 located at a rear portion of the shear edge 14.

A hinged portion of the first shearing unit 100 and the second shearing unit 200 includes a shear elastic opening mechanism and a shear closing locking mechanism.

The shear elastic opening mechanism includes a torsion spring 52, an annular mounting recess 16 for accommodating the torsion spring 52 is formed on an inner side of the blade 10 of the first shearing unit 100, the annular mounting recess 16 is coaxial with the hinge hole 13, and an end-foot recess 161 for accommodating a first torsion arm 521 of the torsion spring 52 is formed on an outer edge of the annular mounting recess 16.

An annular mounting recess 36 for accommodating the torsion spring 52 is formed on an inner side of the blade 30 of the second shearing unit 200, the annular mounting recess 36 is coaxial with the hinge hole 33, and an end-foot recess 361 for accommodating a second torsion arm 522 of the torsion spring 52 is formed on an outer edge of the annular mounting recess 36.

Two ends of the torsion spring 52 are respectively arranged in the annular mounting recess 16 and the annular mounting recess 36 of the blades of the two shearing units, the first spring arm 521 and the torsion spring 52 is arranged in the end-foot recess 161 of the annular mounting recess 16, the second torsion arm 522 of the torsion spring 52 is arranged in the end-foot recess 361 of the annular mounting recess 36, and elastic force of the torsion spring 52 causes the cutting portions of the two shearing units to open.

A rear end of the cutting portion of the blade of each shearing unit is connected to a front end of the handle portion thereof. A rear section of the handle portion 32 of the blade 30 of the second shearing unit 200 is embedded in the plastic handle 40, and riveted to the plastic handle 40 via two rivets 39. A latch slot 35 for receiving the shear closing locking mechanism is formed on an upper portion of a front section of the handle portion 32 of the blade 30 of the second shearing unit 200, and the latch slot 35 is opened rearward. A slot 22 with an opening downward is formed on a front end of the plastic handle 20 of the first shearing unit 100. When the first shearing unit 100 and the second shearing unit 200 are closed, an upper portion of the front section of the handle portion 32 of the blade 30 of the second shearing unit 200 is inserted into the slot 22. A transversely through oblong hole 23 is formed on the front portion of the plastic handle 20 of the first shearing unit 100, and the oblong hole 23 passes through the slot 22 transversely.

The shear closing locking mechanism includes a locking pin 60, where the locking pin 60 includes a rivet 61, a damping spring 62, and a spring washer 63. A clearance hole 17 for receiving the rivet is formed in a position of the handle portion 12 of the blade 10 of the first shearing unit 100 corresponding to the oblong hole 23. Each end of the oblong hole 23 is provided with an elongated annular groove 231, the spring washer 63 is located on a bottom of one elongated annular groove 231, the rivet 61 passes through the damping spring 62, the spring washer 63, the clearance hole 17, and the oblong hole 23, and each end of the rivet 61 is provided with a rivet head 611. One end of the damping spring 62 abuts against the spring washer 63, and the other end abuts against a bottom surface of one rivet head 611, and the other rivet head 611 is located on a bottom of the other elongated annular groove 231. Under the pushing of external force, the locking pin 60 can slide forward and backward along the oblong hole 23, and the damping spring 62 causes the locking pin 60 to stay a position determined by the oblong hole 23.

When the cutter needs to be used, the two shearing units are closed together, the locking pin 60 moves forward in a major axis direction of the oblong hole 23, the rivet 61 is engaged in the latch slot 35 on the upper portion of the front section of the handle portion 32 of the blade 30 of the second shearing unit 200, in which case, the two shearing units that are closed together will not separate, and the plastic handles of the two shearing units are joined to form a handle of the cutter, and the multifunctional chicken bone shears can be then used the cutter. When the shears need to be used, the locking pin 60 moves backward in the major axis direction of the oblong hole 23, the rivet 61 is disengaged from the latch slot 35 on the upper portion of the front section of the handle portion 32 of the blade 30 of the second shearing unit 200, such that the second shearing unit 200 is released. Under the action of elastic force of the torsion spring 52, the cutting portions of the two shearing units open, and the multifunctional chicken bone shears can now be used the shears.

When the multifunctional chicken bone shears needs to be stored, a shear sheath 300 can be applied. The shear sheath 300 includes a plastic sheath 70, a metal clip 80, and a magnet 90. The plastic sheath 70 includes two side plates 71. At an opening portion of a rear portion of the plastic sheath 70, an arc-shaped groove 72 with an opening backward is formed on a first side plate 711, and a central angle α corresponding to the arc-shaped groove 72 is greater than 180°. When the cutting portions of the two shearing units are inserted into the plastic sheath 70, the circular rivet head 511 at the end of the hinge shaft 51 is engaged in the arc-shaped groove 72. A fixed end of the metal clip 80 is secured to a rear end of a second side plate 712 of the plastic sheath 70 via screws 81, and an opening direction of the metal clip 80 faces forward. The second side plate 712 is provided with an elongated hole 73 with its major axis oriented in a front-to-rear direction, and a concave beam 74 is disposed in the elongated hole 73 in a major axis direction. The concave beam 74 is abutted against the cutting portions of the blades of the two shearing units, which can increase clamping force of the plastic sheath 70 on the cutting portions of the multifunctional chicken bone shears.

A circular magnet slot 75 is formed on the second side plate 712, and a circular magnet 90 is embedded in the magnet slot 75. When the cutting portions of the two shearing units are inserted into the plastic sheath 70, the magnet 90 is close to another rivet head 611 at the end of the pivot shaft 51 to increase adhesion of the plastic sheath 70 to the cutting portions of the multifunctional chicken bone shears, preventing the plastic sheath 70 from easily falling off from the cutting portions of the multifunctional chicken bone shears.

In the above embodiments of the present disclosure, the multifunctional chicken bone shears can be directly used as a cutter when the two shearing units are closed together. When the two shearing units are opened, it can be used as shears. The conversion process does not require disassembly or assembly of any parts, making the conversion simple and convenient. In addition, in the above embodiments of the present disclosure, the cutting edge of the multifunctional chicken bone shears may adopt a symmetrical double-sided edge. During cutting, the cutting force is evenly distributed, making the operation easier, less prone to deviation, and having a good cutting effect.

What is claimed is:

1. Multifunctional chicken bone shears, comprising a first shearing unit and a second shearing unit, wherein each shearing unit comprises a blade, the blade comprises a cutting portion and a handle portion, and a hinge hole is formed between the cutting portion and the handle portion of the blade; a hinge shaft passes through the hinge holes of the two shearing units to realize a hinged connection between the two shearing units; and shear edges are provided on opposing portions of the cutting portion on the blade of each shearing unit, wherein the cutting portion on the blade of the first shearing unit is located below the cutting portion on the blade of the second shearing unit, and a cutting edge is arranged beneath the shear edge of the cutting portion on the blade of the first shearing unit.

2. The multifunctional chicken bone shears according to claim 1, wherein the cutting edge is a double-sided edge, and the cutting portion on the blade of the first shearing unit comprises a serrated edge located at a front portion of the shear edge and an arc-shaped concave edge located at a rear portion of the shear edge.

3. The multifunctional chicken bone shears according to claim 1, wherein a hinged portion of the two shearing units comprises a shear elastic opening mechanism and a shear closing locking mechanism.

4. The multifunctional chicken bone shears according to claim 3, wherein the shear elastic opening mechanism comprises a torsion spring, an annular mounting recess of the torsion spring is formed on an inner side of the blade of each shearing unit, the annular mounting recess is coaxial with the hinge hole, and an end-foot recess for accommodating a torsion arm of the torsion spring is formed on an outer edge of the annular mounting recess; and the annular mounting recess of each shearing unit is provided with one torsion spring, two torsion arms of the torsion spring are respectively arranged in the end-foot recesses of the two annular mounting recesses, and elastic force of the torsion spring causes the two shearing units to open.

5. The multifunctional chicken bone shears according to claim 3, wherein each shearing unit comprises a plastic handle, and the handle portion of the blade is embedded in the plastic handle.

6. The multifunctional chicken bone shears according to claim 5, wherein the handle portion of the blade is riveted to the plastic handle via a plurality of rivets, and a top of the plastic handle of the first shearing unit and a bottom of the plastic handle of the second shearing unit are coated with respective silicone layers.

7. The multifunctional chicken bone shears according to claim 5, wherein a rear end of the cutting portion of the blade of each shearing unit is connected to a front end of the handle portion, a rear section of the handle portion of the blade of the second shearing unit is embedded in the plastic handle, and a latch slot that opens rearward for the shear closing locking mechanism is formed on an upper portion of a front section of the handle portion of the blade of the second shearing unit; a slot that opens downward is formed on a front end of the plastic handle of the first shearing unit; when the two shearing units are closed together, an upper portion of the front section of the handle portion of the blade of the second shearing unit is inserted into the slot; a transversely through oblong hole is formed on a front portion of the plastic handle of the first shearing unit, and the oblong hole passes through the slot transversely; the shear closing locking mechanism comprises a locking pin, the locking pin passes through the oblong hole, and a clearance hole for the locking pin is formed on the handle portion of the blade of the first shearing unit; when the two shearing units are closed together, the locking pin moves forward in a major axis direction of the oblong hole and is engaged in the latch slot on the upper portion of the front section of the handle portion of the blade of the second shearing unit; and when the two shearing units are open, the locking pin moves backward in the major axis direction of the oblong hole, and is disengaged from the latch slot on the upper portion of the front section of the handle portion of the blade of the second shearing unit.

8. The multifunctional chicken bone shears according to claim 7, wherein the locking pin comprises a rivet, a damping spring, and a spring washer, each end of the oblong hole is provided with an elongated annular groove, the spring washer is located on a bottom of one elongated annular groove, the rivet passes through the damping spring, the spring washer, and the oblong hole, and each end of the rivet is provided with a rivet head; and one end of the damping spring abuts against the spring washer, and the other end thereofabuts against a bottom surface of one rivet head

9. The multifunctional chicken bone shears according to claim 1, further comprising a shear sheath, wherein the shear sheath comprises a plastic sheath and a metal clip, and the plastic sheath comprises two side plates; at an opening portion of a rear portion of the plastic sheath, an arc-shaped groove is formed on a first side plate, and a central angle corresponding to the arc-shaped groove is greater than 180°; when the cutting portions of the two shearing units are inserted into the plastic sheath, a first rivet head at an end of the hinge shaft is engaged in the arc-shaped groove; a fixed end of the metal clip is secured to a rear end of a second side plate of the plastic sheath via screws, and an opening direction of the metal clip faces forward; and the second side plate is provided with an elongated hole with its major axis oriented in a front-to-rear direction, and a concave beam is disposed in the elongated hole in a major axis direction.

10. The multifunctional chicken bone shears according to claim 9, wherein the shear sheath comprises a magnet, a magnet slot is formed on the second side plate, and the magnet is embedded in the magnet slot; and when the cutting portions of the two shearing units are inserted into the plastic sheath, the magnet is close to a second rivet head at the end of the pivot shaft.
